(19) United States
(12) Patent Application Publication
(10) Pub. No.: US 2009/0296082 A1
(43) Pub. Date: Dec. 3, 2009

(54) Circuit board detecting device and method thereof

(75) Inventors: Hsin-Ching Su, Taipei (TW); Chung-Hwa Chang, Taipei (TW)

Correspondence Address: J C PATENTS, 4 VENTURE, SUITE 250, IRVINE, CA, 92618, US

(73) Assignee: ASUSTeK COMPUTER INC., Taipei (TW)

(21) Appl. No.: 12/386,644

(22) Filed: Apr. 21, 2009

(30) Foreign Application Priority Data
May 28, 2008 (TW) 97119714

(51) Int. Cl. G01N 21/88; G06F 19/00

(52) U.S. Cl. 356/237.5; 702/40

(57) ABSTRACT

A circuit board detecting device and a detecting method are provided. The circuit board detecting device includes an image capture apparatus and a main unit. The image capture apparatus is coupled to the main unit to capture images of the surfaces of a sample circuit board and a test circuit board. In addition, the main unit is used to receive a sample frame and a test frame and compare the images of every object on the sample frame with the images of every object on the test frame to confirm if the test circuit board has flaws on the surface.

### CROSS-REFERENCE TO RELATED APPLICATION

This application claims the priority benefit of Taiwan application serial no. 97119714, filed on May 28, 2008. The entirety of the above-mentioned patent application is hereby incorporated by reference herein and made a part of specification.

### BACKGROUND OF THE INVENTION

1. Field of the Invention

The invention relates to a device for detecting a circuit board and a method thereof and, more particularly, to a device for detecting a circuit board using image comparison and the method thereof.

2. Description of the Related Art

With the progress of the electronic science and technology, electronic components become a necessary part in people's life. The circuit boards used to carry various electronic components also can be seen everywhere. To facilitate the mass production, the technology of the printed circuit board is mature and is used widely. The printed circuit board is not only easy to be manufactured, but also cheap in price. However, there is no efficient method to detect the quality of the printed circuit board. The conventional method for detecting the printed circuit board is achieved by human eyes. The method needs a lot of manpower, and it is also easy to make mistakes. This is neither economical nor exact. Furthermore, under the circumstance that the manufacturing technology is continuously updated, and the electronic components and the used circuit become precise day by day, the detecting method by human eye may not meet the demand for mass production. For example, it may not be used in the circuit board of the ball grid array (BGA). Therefore, an automatic detecting device needs to be produced.

Most of the conventional devices for detecting the automatic printed circuit boards analyze a Gerber file of the tested printed circuit board. However, the Gerber file only can be used to detect whether the connection of the copper wire of the tested printed circuit board is correct, and it cannot detect the flaws appeared when the printed circuit board is etched, pressed, painted by solder mask, and printed with characters during the manufacturing process. Besides this, there is a method in the conventional technology using the color model changing mode. However, in the method, the calculating of the color coordinate transformation (such as the chromatic aberration coordinate transformation) is difficult. It is inconvenient to be used in application. In addition, the method only can detect the inner circuit of the copper foil of the printed circuit board, and it does not satisfy all the demands.

### BRIEF SUMMARY OF THE INVENTION

The invention provides a circuit board detecting device which may detect the surface of a circuit board quickly using simple equipment.

The invention also provides a method for detecting a circuit board, which may detect whether a circuit board has flaws on the surface effectively.

The invention provides a circuit board detecting device including an image capture apparatus and a main unit. The image capture apparatus may capture images of the surfaces of a sample circuit board and a test circuit board and generate a sample frame and a test frame, respectively. In the sample frame and the test frame, multiple objects on the surfaces of the sample circuit board and the test circuit board may be shown. In addition, the main unit is coupled to the image capture apparatus to receive the sample frame and the test frame captured by the image capture apparatus. The main unit detects if the test circuit board has flaws on the surface by comparing images of every object of the sample frame with that of the test frame.

In another aspect, the invention provides a method for detecting the circuit board including capturing an image of the surface of a sample circuit board and generating a sample frame. The sample frame may show multiple images on the surface of the sample circuit board. In addition, in the invention, an image of the surface of a test circuit board is captured to generate a test frame. Similarly, the test frame is used to show the images of the objects on the surface of the test circuit board. Therefore, in the invention, the images of the objects of the sample frame are compared with the images of the objects of the test frame to confirm if the circuit board has flaws on the surface.

In an embodiment of the invention, the step of comparing the sample frame with the test frame includes analyzing the color information of the objects on the sample frame to obtain multiple reference values. In addition, the color information of the objects on the test frame is analyzed to obtain multiple comparing values. After the reference value and the comparing value are obtained, they are compared with each other. When a comparing value exceeds a preset range of the corresponding reference value, it is confirmed that the test circuit board has flaws on the surface.

Since in the invention, the images are captured from the surfaces of the sample circuit board and the test circuit board, whether the test circuit board has flaws on the surface is detected quickly by comparing the patterns on the two images.

These and other features, aspects and advantages of the present invention will become better understood with regard to the following description, appended claims, and accompanying drawings.

### BRIEF DESCRIPTION OF THE DRAWINGS

FIG. 1 is a block diagram showing a circuit of a circuit board detecting device according to an embodiment of the invention;

FIG. 2 is a flow chart showing the steps of the method for detecting the circuit board according to a preferable embodiment of the invention;

FIG. 3 is a flow chart showing the steps of analyzing the sample circuit board according to a preferable embodiment of the invention;

FIG. 4 is a schematic diagram showing a sample frame; and

FIG. 5 is a flow chart showing the steps of comparing the test circuit board in a preferable embodiment of the invention.

### DETAILED DESCRIPTION OF THE EMBODIMENTS

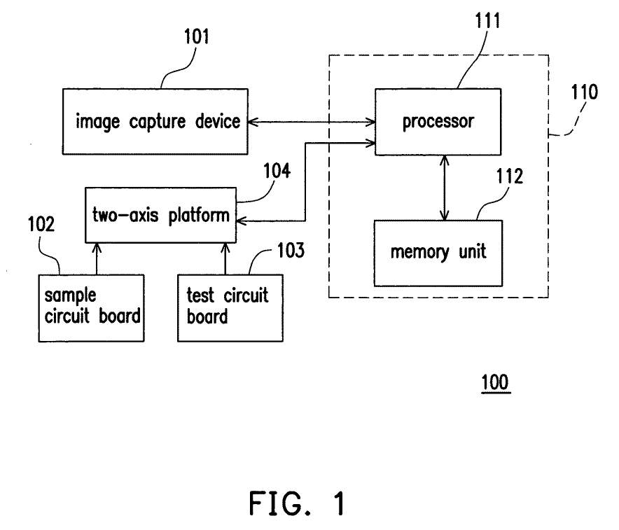

FIG. 1 is a block diagram showing a circuit of a circuit board detecting device according to a preferable embodiment of the invention. As shown in FIG. 1, the circuit board detecting device 100 provided in the embodiment includes an image capture apparatus 101, a main unit 110 and a two-axis platform 104. Both the image capture apparatus 101 and the two-axis platform 104 may be coupled to the main unit 110. The two-axis platform 104 is used to carry the circuit board, and the image capture apparatus 101 may capture the image of the circuit board on the two-axis platform 104. In the embodiment, the image capture apparatus 101 may be achieved by a camera device.

The main unit 110 includes a processor 111 and a memory unit 112. The processor 111 may be coupled to the memory unit 112 and also may be coupled to the image capture apparatus 101 and the two-axis platform 104. Therefore, the processor 111 may receive the image captured by the image capture apparatus 101 and control the movement of the two-axis platform 104. In the embodiment, the two-axis platform 104 may move on a plane according to the control of the processor 111. In the embodiment, the main unit 110 may be achieved by a personal computer.

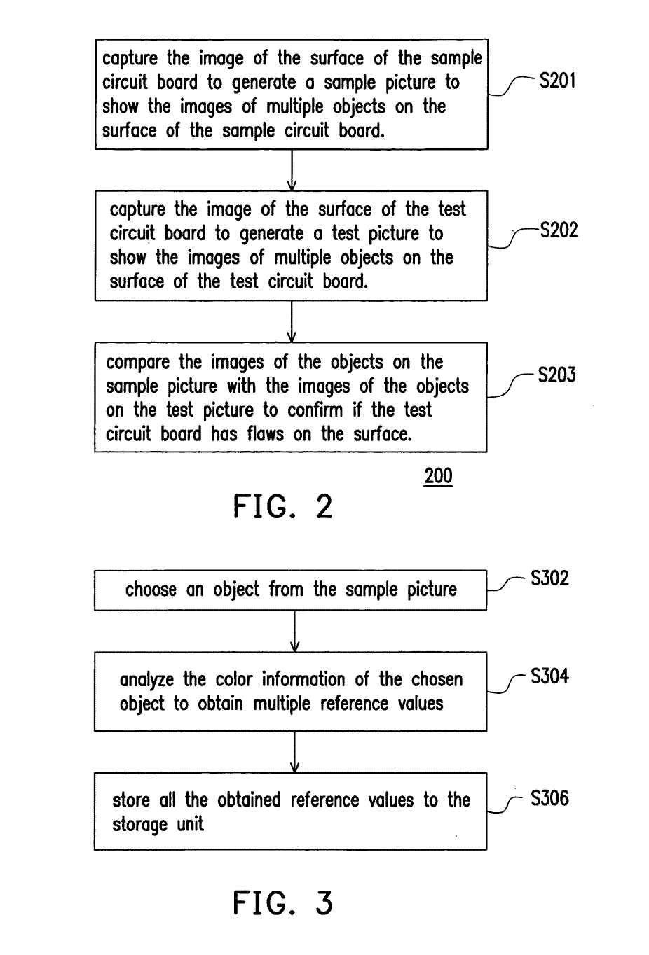

FIG. 2 is a flow chart showing the steps of the method for detecting the circuit board according to a preferable embodiment of the invention. As shown in FIG. 1 and FIG. 2, before a detector detects a surface of a circuit board using the circuit board detecting device 100, he or she may lay a standard sample circuit board 102 on the two-axis platform 104. Therefore, according to step S201, the image capture apparatus 101 may capture an image of the surface of the sample circuit board 102 and generate a sample frame to the main unit 110. The sample frame shows multiple images of the objects on the surface of the sample circuit board 102, such as the metal conducting wire, the solder mask, the green paint on the base, the holes and the printed characters. When the processor 111 obtains the sample frame, it may store the sample frame in the memory unit 112 first.

At that moment, the detector may lay the test circuit board 103 on the two-axis platform and operate the image capture apparatus 101 to perform step S202. That is, the image of the surface of the test circuit board 103 is captured and a test frame is generated to the main unit 110. Similarly, the test frame may show the images of the objects on the surface of the test circuit board 103. When the main unit 110 receives the sample frame and the test frame, step S203 is performed. The images of the objects of the sample frame are compared with those of the test frame to confirm if the test circuit board 103 has flaws on the surface.

In the embodiment, when the sample frame and the test frame need to be captured, the sample circuit board 102 and the test circuit board 103 are located first. That is, when the detector lays the sample circuit board 102 or the test circuit board 103 on the two-axis platform, the main unit 110 may find an optical locating point on the circuit board via the image capture apparatus 101 to accurately calculate the relative position between the sample circuit board 102 and the test circuit board 103 to avoid the mistake during analyzing.

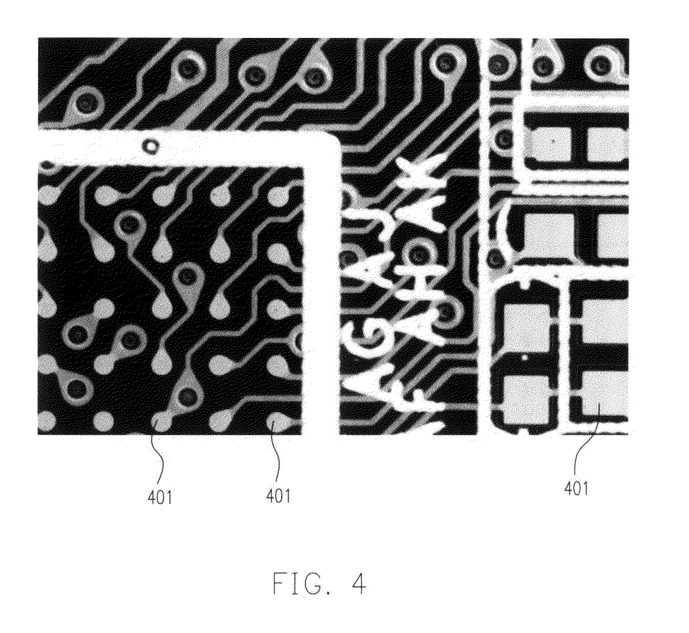

FIG. 3 is a flow chart showing the steps of analyzing the sample circuit board according to a preferable embodiment of the invention. As shown in FIG. 1 and FIG. 3, when the main unit 110 obtains a sample frame of the surface of a sample circuit board 102 through an image capture apparatus 101, step S302 is performed. That is, according to the input of the user, an object is chosen from the sample frame. In addition, the main unit 110 may set a color range for the selected object and obtain related color information according to the input of the user, as shown in step S304. An embodiment is hereinbelow to illustrate the step above.

FIG. 4 is a schematic diagram showing a sample frame. As shown in FIG. 4, the sample frame may show multiple objects on the surface of a sample circuit board 102. As shown in FIG. 1, FIG. 3 and FIG. 4, assuming that the object denoted by the number 401 is the metal conducting wire on the sample circuit board 102, when the main unit 110 obtains the sample frame shown in FIG. 4, an object may be chosen from the sample frame according to the user's input. Assuming that the user chooses the metal conducting wire 401, the main unit 110 also may analyze the color information of the chosen object according to the user's input.

Every object on a circuit board has a corresponding color range. Therefore, when the corresponding object data of every object, such as the color information of the object, is analyzed, multiple reference values may be obtained. For example, the color values of red, blue and green are obtained, and the color range of the chosen object is composed of these color values. In other embodiments, the obtained reference values further include a blue chromatic aberration value and a red chromatic aberration value. The blue chromatic aberration value is the difference value of the blue color value and the green color value in the preset color. Similarly, the red chromatic aberration value is the difference value of the red color value and the green color value in the preset color.

In addition, in some embodiments, after the main unit 110 obtains related color information, step S306 is performed, and the obtained reference values are stored to the memory unit 112.

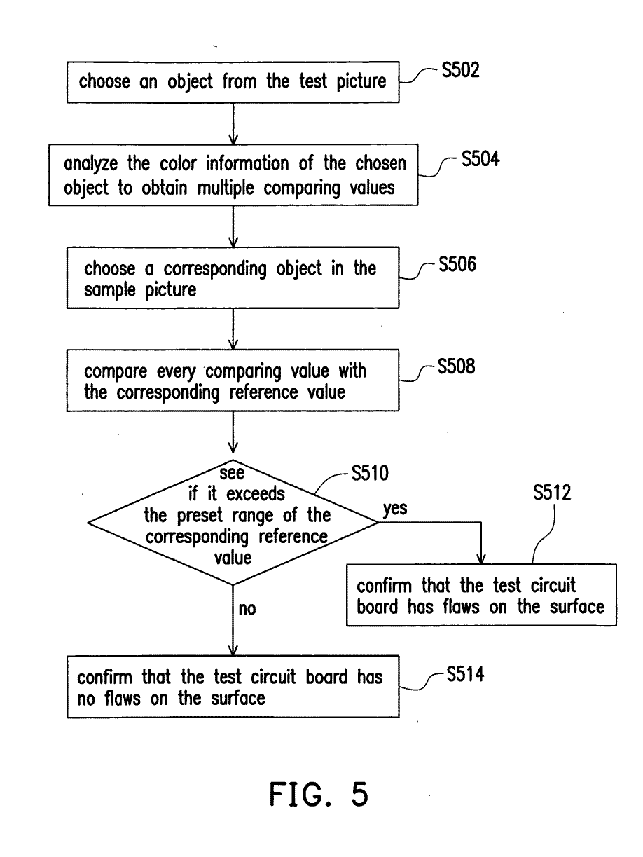

FIG. 5 is a flow chart showing the steps of comparing the test circuit board according to a preferable embodiment of the invention. As shown in FIG. 1 and FIG. 5, when the main unit obtains the test frame of a surface of the test circuit board 103 through the image capture apparatus 101, as shown in step S502, an object is chosen from the test frame according to the user's input. At that moment, the main unit 110 may perform step S504 according to the user's input. That is, the main unit analyzes the color information of the chosen object and obtains multiple comparing values. For example, the main unit 110 analyzes the color ranges of the chosen object to obtain the color values of red, blue and green, and the color range is composed of these color values. In some chosen embodiment, the blue chromatic aberration value and the red chromatic aberration value are further included.

The main unit 110 may choose the corresponding object in the sample frame according to the user's input, as shown in step S506. Then, the main unit 110 compares each comparing value with the corresponding reference value (as shown in step S508). For example, the comparing value of the metal conducting wire of the test frame is compared with the reference value of the metal conducting wire 401 of the sample frame in FIG. 5. The main unit herein may detect whether any of the comparing value exceeds a preset range of the corresponding reference value.

If a comparing value such as the red color value in the color range of the chosen object is detected to exceed a preset range of the reference value (that is, the “yes” denoted in S510), and then, the main unit confirms that the test circuit board 103 has flaws on the surface, as shown in step S512. Correspondingly, if none of the comparing values exceeds the preset range of the corresponding reference value (the “no” denoted in step S510), the main unit 110 may confirm that the chosen object of the test circuit board 103 has no flaws on the surface. Then, similar detections are performed on other objects. If none of the comparing values of every object on the surface of the test circuit board 103 exceeds the preset range of the corresponding reference value, it is primarily determined that the test circuit board 103 has no flaws on the surface.

To sum up, in an embodiment of the invention, a simple color comparison is used to detect the circuit board. Therefore, in the embodiment of the invention, expensive equipment is not needed. In addition, in the embodiment of the invention, the red color value, the green color value, the blue color value, the red chromatic aberration value and blue chromatic aberration value are used to be compared. Therefore, the embodiment of the invention does not need complex calculating method.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A circuit board detecting device comprising:
an image capture apparatus for capturing an image of a surface of a sample circuit board and an image of a surface of a test circuit board to generate a sample frame and a test frame, respectively, wherein the sample frame and the test frame are used to show multiple objects on the surfaces of the sample circuit board and the test circuit board, respectively; and
a main unit coupled to the image capture apparatus to receive the sample frame and the test frame and comparing the image of each of the objects on the sample frame with the image of each of the objects on the test frame to confirm if the test circuit board has flaws on the surface.

2. The circuit board detecting device according to claim 1, wherein the sample circuit board and the test circuit board are printed circuit boards.

3. The circuit board detecting device according to claim 1, further comprising a two-axis platform coupled to the main unit and carrying the sample circuit board and the test circuit board, wherein the two-axis platform moves on a plane according to the control of the main unit.

4. The circuit board detecting device according to claim 1, wherein the image capture apparatus is a camera.

5. The circuit board detecting device according to claim 1, wherein the objects comprise metal conducting wires, green paint, solder mask, holes or characters.

6. The circuit board detecting device according to claim 1, wherein the main unit comprises:
a processor; and
a memory unit, coupled to the processor, for storing object data worked out by the processor.

7. The circuit board detecting device according to claim 1, wherein the main unit comprises a personal computer.

8. The circuit board detecting device according to claim 6, wherein the object data comprises color ranges of a red color value, a blue color value and a green color value.

9. The circuit board detecting device according to claim 8, wherein the object data further comprises a red chromatic aberration value and a blue chromatic aberration value.

10. A method for detecting a circuit board comprising the steps of:
capturing an image of a surface of a sample circuit board to generate a sample frame having multiple images of objects;
capturing an image of a surface of a test circuit board to generate a test frame having the images of objects; and
comparing the images of the objects on the sample frame with the images of the objects on the test frame to confirm if the test circuit board has flaws on the surface.

11. The method for detecting the circuit board according to claim 10, wherein the step of comparing the sample frame comprises the steps of:
choosing one of the objects from the sample frame according to an input of a user;
analyzing color information of the chosen object to obtain multiple reference values; and
storing the reference values.

12. The method for detecting the circuit board according to claim 11, wherein the step of comparing the test circuit board comprises the steps of:
choosing one of the objects from the test frame according to an input of a user;
analyzing the color information of the chosen object to obtain multiple comparing values;
choosing the corresponding object in the sample frame to obtain corresponding reference values;
comparing each of the comparing values with the corresponding reference value, respectively; and
when one of the comparing values exceeds a preset range of the corresponding reference value, determining that the test circuit board has flaws on the surface.

13. The method for detecting the circuit board according to claim 12, further comprising the steps of:
when none of the comparing values of all the objects in the test frame exceeds the preset range of the corresponding reference value, determining that the test circuit board has no flaws on the surface.

14. The method for detecting the circuit board according to claim 12, wherein the reference values and the comparing values are corresponding ranges of a red color value, a green color value and a blue color value of the objects, respectively.

15. The method for detecting the circuit board according to claim 12, wherein the reference values and the comparing values are a corresponding red chromatic aberration value and a corresponding blue chromatic aberration value of the objects, respectively.
